(19) United States
(12) Patent Application Publication
(10) Pub. No.: US 2019/0043278 A1
(43) Pub. Date: Feb. 7, 2019

(54) TEST DRIVE SCENARIO SYSTEM FOR VIRTUAL TEST DRIVE SCENARIOS

(71) Applicant: FORD GLOBAL TECHNOLOGIES, LLC, Dearborn, MI (US)

(72) Inventors: Frederic STEFAN, Aachen (DE); Alain Marie Roger CHEVALIER, Henri-Chapelle (BE); Evangelos BITSANIS, Aachen (DE); Michael MARBAIX, Haillot (BE)

(73) Assignee: FORD GLOBAL TECHNOLOGIES, LLC, Dearborn, MI (US)

(21) Appl. No.: 16/050,043

(22) Filed: Jul. 31, 2018

(30) Foreign Application Priority Data
Aug. 1, 2017 (DE) 10 2017 213 217.5

(51) Int. Cl. G07C 5/08; G06F 17/30; G07C 5/00; G07C 5/12

(52) U.S. Cl. CPC G07C 5/0808; G06F 17/30377; G06T 17/05; G07C 5/12; G07C 5/008

(57) ABSTRACT

A test drive scenario database system for highly realistic, virtual test drive scenarios comprises at least one device that generates a virtual scene, a database memory and a control device. The control device has at least one data receiving unit with one or more data receiving interfaces, a configuration unit with at least one user interface and a data output unit with at least one data output interface. The device that generates a virtual scene is configured to display real, test drive scenario data in a virtual scenario, in which one or more parameters of the output test drive scenario data can be changed.

### CROSS-REFERENCE TO RELATED APPLICATIONS

This application claims foreign priority benefits under 35 U.S.C. § 119(a)-(d) to DE Application 10 2017 213 217.5 filed Aug. 1, 2017, which is hereby incorporated by reference in its entirety.

### TECHNICAL FIELD

The present disclosure relates to a test drive scenario database system and method for highly realistic virtual test drive scenarios.

### BACKGROUND

Virtual worlds are computer-generated environments that are usually displayed three-dimensionally and convey to a user, for example using interaction with a virtual environment, an impression that, for example, the user can change their viewing direction of displayed objects or change their position and “move” within the environment.

Virtual environments are used, for example, in the computer games industry, but also as tools for product design and development, where a developer, for example using a virtual model, can customize and test a design for a product that is to be actually manufactured.

Also, there is sometimes sufficient information available on actual scenes and scenarios on which to base a generated virtual scenario as a model of the real-world scenario, which represents actually determined data in an appropriately realistic way.

For example, in order to reconstruct a traffic accident, US 2010/0030540 provides a means for generating a three-dimensional accident environment using position data, geographical data and weather data, and for displaying vehicle data recorded by a black box of the vehicle, data relevant to a condition of a driver, data from sensors on a road if appropriate and geographical information in a scene, and also for displaying other objects relevant to the accident, such as vehicles in a vicinity, pedestrians and traffic lights in the scene.

Development and improvement of vehicles and vehicle components can also be improved by testing in a realistic virtual environment, by evaluating real test drives in a virtual environment and, for example, an ability to perform series of experiments with virtual test drives customized to real problems currently occurring.

In particular, with development of autonomous vehicles that are in communication with one another, a need for reliable tests and simulations has risen, in order to take account of all possible eventualities in complex traffic situations, and to adapt a behavior of new vehicle components, for example control software for an autonomous or self-driven vehicle without a driver, to the vehicle components. For example, it may be important to capture environmental conditions under which a specific behavior of the control software has occurred and why, for example, a traffic situation was judged to be inappropriate or why, despite correct assessment, a critical situation nevertheless arose.

In order to adequately isolate actually occurring problems and be able to identify causes, it is usually necessary to also capture complex interrelationships, interactions and an influence of different components of a respective test drive scenario on each other, which is only possible to a limited extent with analysis of individual test drives.

### SUMMARY

An object of the present disclosure is to provide, in a simple manner, various different virtual test drive scenarios derived from real test drives that can be evaluated as realistically as possible.

In accordance with one aspect of the disclosure, a test drive scenario database system according to the disclosure for realistic virtual test drive scenarios comprises at least one device that generates a virtual scene, a database memory and a control device. The control device has at least one data receiving unit with one or more data receiving interfaces, a configuration unit with at least one user interface and a data output unit with at least one data output interface. The data receiving unit is configured to receive test drive scenario data from a plurality of real test drives of at least one first test vehicle having at least one first vehicle component to be tested, and to store said data in the database memory. The configuration unit is configured such that using said unit, a user of the test drive scenario database system can add at least one annotation to test drive scenario data from at least a portion of at least one of the plurality of real test drives. And a data output unit is configured to output test drive scenario data from at least the portion of the at least one of the plurality of real test drives, to which the annotation was added, to the device that generates a virtual scene, wherein the device that generates a virtual scene is configured to display output test drive scenario data in a virtual scenario in which one or more parameters of the output test drive scenario data can be changed.

A real test drive, in contrast to a virtual test drive, is performed with a real test vehicle, i.e. not with a virtual representation of a test vehicle, so that a recorded test drive scenario data relate to values of real parameters of the test vehicle such as a test vehicle geographical position, speed, etc., and, for example parameters of the driver, an environment of the test vehicle, of other vehicles and other road users.

A test vehicle is a vehicle controlled by a driver or an autonomously driven vehicle, which has at least one vehicle component to be tested. This implies that a structural addition or change is tested, but also any change in a control or operating software, or an operating process or even in the entire vehicle, also including, for example, a test of the vehicle for specific user groups, or in specific test environments. The test vehicle is connected or connectable to the database system by wireless or wired communication. In one embodiment, it is a mobile component of the system and/or a part of the system.

The control device allows, among other things, the wireless or wired communication between data sources, for example a first test vehicle and environmental information databases, the database memory of the test drive scenario database system and the device that generates a virtual scene. Preferably, all components of the system are communicatively connected to each other either by wired or wireless communication, for example via 3G, 4G, 5G or another generation of wireless network, and are located, for example, in a same data cloud or connected to each other over a data network.

A test drive scenario database system comprises the database memory, for example as a non-volatile memory or storage facility in a cloud, which the control device can access, and the device that displays, i.e. generates and renders a virtual scene, which can be, for example, a programmable device with an output device such as a screen or a head-mounted display, which receives the test drive scenario data that a user has selected for display from the data output unit of the control device. The control device is also a programmable device with a processor and a memory. In one embodiment, it is provided that the control device and the device that generates a virtual scene are implemented as a common device.

The test drive scenario data is selected for transfer to the device that generates a virtual scene by the user, for example a development engineer, using a user interface of the configuration unit, which may be a graphical user interface, for example, then annotating at least a portion of the test drive scenario data from at least one of the test drives, which means adding at least one marking, and thus selecting the marking for display. For example, a period of time within a recorded test drive can be selected for display.

In one embodiment, it is provided that selected parts of the test drive scenario data are stored as separate data sets during the annotation. In this way it is possible, for example, to combine test drive scenario data sets relating to special scenarios to be examined into separate databases or database areas for analysis, for example those relating to traffic situations that have so far not been sufficiently considered, or situations in which the test vehicle has behaved differently than expected, or which have led to a critical situation or have not been sufficiently taken into account during a development process.

In a further embodiment, it is provided that the annotation operation comprises addition of further settings that reproduce the test drive scenario or other additional information. In one embodiment, it is provided that the user interface of the configuration unit is implemented by the device that generates a virtual scene, with which a direct selection or annotation of the test drive scenario data to be displayed is possible. In one embodiment the configuration unit also allows other information on the test drive scenarios to be retrieved and added to the test drive scenario data by annotation, for example historical data, special events or information about a test campaign to which the test drive belongs. In addition, in one embodiment in a test drive scenario with a plurality of vehicles, such as a fleet of interconnected vehicles, it is provided that one can be selected as a test vehicle.

The test drive scenario data is transferred via the data receiving interface or a plurality of data receiving interfaces to the data receiving unit of the control mechanism. The design of these is determined by relevant data sources. Sensors preferably already provide sensor signals in a digital representation. Analog sensor signals are converted into digital signals by the data receiving unit, if necessary. If the data are available via other databases that can be accessed via a wireless or wired connection, one appropriately designed interface is provided in each case.

Via a data output interface of the data output unit of the control device, the test drive scenario data to be output that was selected for display by the user by their annotation is sent to the device that generates a virtual scene. In this connection it can be provided that corresponding virtual representations of objects to which the output test drive scenario data are mapped, for example a virtual representation at least of the test vehicle, possibly with a vehicle component to be tested, and of other road users, are calculated by the device that generates a virtual scene. In another embodiment, it is provided that the control unit already associates corresponding additional information when saving or storing received test drive scenario data and also stores it in the database, so that the test drive scenario data to be output already include this.

The data receiving unit, the configuration unit and the data output unit of the control device are implemented either as a common module or else have interfaces to be able to communicate with each other, or have at least one interface for write or read access to the database memory.

The test drive scenario database system for highly realistic virtual test drive scenarios provides a way of capturing different data characterizing a real test drive, both of the test vehicle or the vehicle component to be tested together with data characterizing ambient conditions during the test drive at a same time and storing them in a database, so that a highly realistic virtual test drive can be reconstructed on the basis of the stored data.

By providing test drive scenario datasets for different test drives in a common database, from which the user selects and edits the data to be displayed for the virtual test drive scenario to be displayed, it is possible not only to investigate relationships and dependencies between parameters of the test drive scenarios in a targeted way rather than merely analyzing individual incidents such as accidents in isolation, but also to identify and analyze complex dependencies in extensive scenarios. In addition, for example more meaningful evaluations of test drives can be obtained by interrogating test drivers during a “re-run” of driving situations in the virtual test drive scenario, which can then be examined, for example with a same test driver in modified scenarios. If the vehicle is an autonomously driven vehicle, then passengers in the test drive can be interrogated.

In one embodiment, the device that generates a virtual scene comprises not only facilities for displaying and interacting with a test drive scenario, but has a driving simulator device, or is connected with the same, with which for example the virtual representation of the test vehicle in a virtual test drive can be driven through the test drive scenario by a user of the driving simulator device, so that a test driver's reactions to changes in the test drive scenario, including the virtual representation of the test vehicle, can be examined.

The test drive scenario database system described allows whole test drive scenarios, or selected parts of them, and/or the recorded data of the actual test environment, and the actual test vehicle to be stored, including movements or data from which a movement can be reconstructed, for example positions over time, so that the real test drive can be repeated virtually or the real test environment can be virtually modeled. Since not just one test drive or one test environment is stored, but many of them, whole scenarios or parts thereof can be compared and parts can be selected so that certain situations which are, for example, critical or in which the vehicle or the vehicle component to be tested has behaved unexpectedly, are taken into account in advance in further developments, or else can be taken into account in other virtual test drives, for example when conducting a virtual user clinic (“customer clinic” or “car clinic”), where test subjects test a new vehicle or new vehicle component in a virtual 3D world.

In one embodiment of the test drive scenario database system, received test drive scenario data comprise at least position data of the first test vehicle at a plurality of times or continuously between a corresponding beginning and a corresponding end of a respective test drive. The term “between” here can also comprise points at the beginning and end of the test drive. The position data are values of a driving parameter and can be determined, for example, by a Global Positioning System (“GPS”). In this way, an exact route of the test drive can be determined and stored for generating a corresponding virtual test drive scenario. If each measurement time is also captured, a speed profile of the first test vehicle can also be tracked. To do this, the test drive scenario data can comprise time information, for example a universal time indication, which is determined by a clock on board the test vehicle.

In a further embodiment, the received test drive scenario data comprise values of at least one other driving parameter of the first test vehicle, either at the plurality of times or continuously between the corresponding beginning and the corresponding end of a respective test drive. These include, for example, a number and/or extent of steering movements, speed and/or acceleration of the vehicle, yaw, pitch, a condition of vehicle headlights, of a windshield wiper, a selected gear and/or shifting time, etc. Measured values of the driving parameter, or parameters, are either transmitted wirelessly to the data input unit of the control device, or can be recorded by the first test vehicle and transmitted to the data input unit of the test drive scenario database system later. An acquisition of one or more further drive parameters allows an improved, highly realistic reconstruction of the test drive in a virtual test drive scenario. Similarly, RCP (“Rapid Control Prototyping”) signals or other signals sent via a vehicle bus (e.g. CAN (“Controller Area Network”)) can either be sent to the control device as part of the test drive scenario data or else can be first stored in a memory of the first test vehicle for later transfer.

In a preferred embodiment, the received test drive scenario data comprise environmental data of a surrounding area around a position of the first test vehicle. In one embodiment the surrounding area is defined, for example, by a certain radius around the position of the test vehicle. Environmental data can be, for example, topographic data or infrastructure information, such as positions and dimensions of objects, for example positions of traffic lights and other traffic signs, a trajectory and width of roads, road gradients where appropriate, height information and/or road surface information, position, size and orientation of buildings, but also, for example, weather data for a time of the test drive, changes in a status of traffic lights etc. Depending on an intended purpose of the test drive scenario database, a collection of certain parameter values and/or their use in subsequent creation of a corresponding virtual test drive scenario may be particularly advantageous or in some cases, unnecessary.

In an exemplary embodiment, the environment data comprise data from at least one environmental information database. In this case, either the environmental information database or environmental information databases is, or are or can be, connected to the test drive scenario database system or else are part of the test drive scenario database system, and connected to the control device, for example via wired or wireless connection(s). For example, a connection can be implemented via the internet. An environmental information database can be, for example, a weather data server or map information server. Information about, for example, temperature, humidity, rain, snow, visibility conditions and/or historical weather data can be retrievable from the weather data server. From a map server, two-dimensional and/or preferably, three-dimensional mapping information on surroundings of the vehicle position are retrievable. This offers an advantage that a nature of the environment can be displayed in a virtual environment to be created, and therefore for example, decisions or behaviors of the driver related to the nature of the environment (for example, lack of visibility of a curve or intersection) are able to be tracked. The test drive scenario database system allows an impact of a modified environmental parameter to be investigated, for example by comparing different test drive scenarios in which certain environmental parameters were the same or different.

In a further exemplary embodiment, the environmental data comprise further data collected from one or more sensors of the first test vehicle. In addition to, or instead of, collection of environmental data that is available in relevant environmental databases, this embodiment provides that sensors of the first test vehicle can use signals of devices such as in-vehicle radar, lidar and/or camera systems, rain or temperature sensors in order to detect other environmental data in addition to data on other road users, such as traffic signs, buildings and/or weather conditions. This provides at least an advantage of being able to record environmental data, regardless of an existence of a connection to the respective environmental information database, at any time during the test drive and therefore to be able to capture data uniquely relevant to the test drive irrespective of a currency of available data in the respective environmental information database. If data is available from an environmental information database, then using signal echoes of respective vehicle sensors allows, for example, position data to be corrected and unidentified echo information assigned to associated objects.

In one embodiment, the received test drive scenario data comprise position data of one or more other road users, such as other vehicles, pedestrians or cyclists during a time of the test drive, i.e. with motion information, in an area around the test vehicle. For this purpose, for example, sensor data from one or more sensors is analyzed, for example from image sensors mounted on the first test vehicle. Instead or in addition, to capture the position data, it is also possible, if available, to use a direct communication, for example using a vehicle-to-vehicle (V2V) communication link or an infrastructure-to-vehicle (I2V) communication link (for example traffic light-to-vehicle), or a pedestrian-to-vehicle (P2V) communication link. Position data from pedestrians are collected via smartphones, for example. Information about other road users and a traffic situation can also be obtained from traffic information systems and traffic information databases, for example traffic density, position of a traffic jam or an accident site, or information about a traffic flow, for example, traffic light states or traffic light phases.

In one embodiment, the first vehicle component to be tested comprises control software, and the one or more parameters, or at least one of these parameters of the output test drive scenario data, are parameters of the control software. In this way, changes to a control software component can also be tested and validated.

In a further embodiment of the test drive scenario database system, the data receiving unit is configured also to receive test drive scenario data from real test drives of at least one second test vehicle, which has at least the first or another vehicle component to be tested, and to save said data in the database memory. This has an advantage that, for example, test drives with different test vehicles, but the same or a similar vehicle component to be tested, can be captured by the test drive scenario database system.

In an exemplary embodiment, the data receiving unit is configured to receive the test drive scenario data of simultaneous real test drives of the first and second test vehicle, and to store said data in the database memory. In this way, more complex traffic situations can also be stored for a realistic, virtual test drive scenario, in order for example to be able to analyze dependencies between vehicles or of vehicle fleets that exchange data with one another, for example via a V2V communication link. To reach the control unit of the database system, the data are either transferred from each of the test vehicles separately, or all data are transferred to the first test vehicle, which communicates with the control device of the test drive scenario database system.

In one embodiment, the data receiving unit is configured to receive the test drive scenario data, at least in part, via a wireless connection. This applies in particular to data received from test vehicles, but can also apply, for example, to environmental information data servers that can be accessed, for example, directly over a mobile wireless network or can be connected thereto via the internet or other communication network, and that are implemented, for example, as a server in a cloud.

In one embodiment, the device that generates a virtual scene comprises an analysis unit, which is configured to analyze dependencies between different test drive scenario data. For this purpose, a unit of analysis can compile, for example, statistics or tables, showing how, e.g. one of the parameters changes if another one is changed, so that dependencies and interrelationships can be tracked and evaluated. For example, dependence of fuel consumption of the test vehicle on a number of other road users, weather, etc. can be investigated. To do this, e.g., a facility exists to manipulate a virtual scene and capture effects, and/or to compare data from multiple test runs with different parameter settings. In one embodiment, it is provided that visualization of progress of a selected test drive can be controlled via control commands (for example, play, pause, forwards, backwards).

In one exemplary embodiment, the analysis unit is configured to automatically annotate changes in the test drive scenario data, which exceed associated tolerance ranges, as special events. These may include, for example, sudden steering movements or braking operations. A use in the context of the test drive scenario database system enables a detailed analysis of causes of events. If an event detection is performed for multiple road users in a test drive scenario or if different test runs are compared, this allows relationships to be more easily identified (including visually). For example, it might be analyzed and recognized that when a speed is above a threshold value, an obstacle that appears in a particularly surprising way gives rise to a dangerous steering movement, but at a reasonable speed below a threshold by contrast, it does not.

In a further embodiment, the analysis unit is also configured to apply a learning algorithm, which makes it possible to determine causal relationships between events from a sequence of detected events.

According to a further aspect of the disclosure, the method according to the disclosure relates to a method for examining test drives with a test drive scenario database system for highly realistic virtual test drive scenarios. It is provided that the method is executed with a test drive scenario database system in accordance with one of the above-described embodiments. In this way, benefits and particular features of the test drive scenario database system according to the disclosure are also realized in the context of a method for examining test drives with a test drive scenario database system.

For this purpose, the method is implemented for examining test drives with a test drive scenario database system for highly realistic virtual test drive scenarios, which comprises at least one device that generates a virtual scene, a database memory and a control device at least with a data receiving unit having one or more data receiving interfaces, with a configuration unit having at least one user interface and with a data output unit having at least one data output interface.

The method comprises, at least, using the data receiving unit to receive test drive scenario data from a plurality of real test drives of at least one first test vehicle, which has at least one first vehicle component to be tested, and to store said data in the database memory, using the configuration unit to add at least one annotation of a user of the test drive scenario database system to test drive scenario data from at least a part of at least one of the plurality of real test drives, using the data output unit to output test drive scenario data from at least a part of the at least one of the plurality of real test drives, to which the annotation has been added, to the device that generates a virtual scene, and using the device that generates a virtual scene to display the output test drive scenario data in a virtual scenario in which one or more parameters of the output test drive scenario data can be changed.

Further advantages of the present disclosure is apparent from the detailed description and the Figures. The disclosure is explained in more detail hereafter with the following description of exemplary embodiments and with reference to the enclosed drawings.

### BRIEF DESCRIPTION OF THE DRAWINGS

FIG. 1 depicts a schematic illustration of an example of a test drive scenario database system for realistic virtual test drive scenarios in accordance with an embodiment of the disclosure; and

FIG. 2 a schematic illustration of an example of a method for examining test drives with a test drive scenario database system in accordance with another embodiment of the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

It is understood that other embodiments can be used and structural or logical changes can be made without departing from the scope of protection of the present disclosure. It goes without saying that the features of the various exemplary embodiments described above and hereafter can be combined with one another, unless specifically stated otherwise. The description is therefore not to be understood in a restrictive sense, and the scope of protection of the present disclosure is defined by the attached claims.

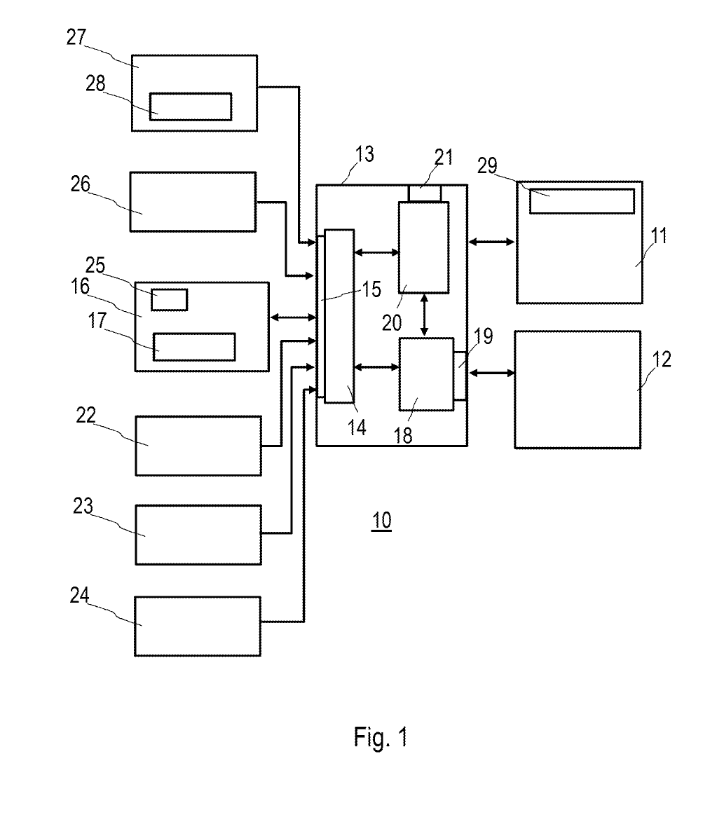

FIG. 1 shows a schematic view of an example of a test drive scenario database system for realistic virtual test drive scenarios in accordance with an embodiment of the disclosure. The illustrated test drive scenario database system 10 for realistic virtual test drive scenarios comprises a device 11 that generates a virtual scene. This has at least one programmable device and a display, so that based on test drive scenario data selected for display, a virtual test drive scenario is generated and can be displayed on the display, for example a touch screen or head-mounted display. The device that generates a virtual scene can in particular also comprises a driving simulator, or may be included therein.

In addition, the test drive scenario database system 10 shown has a database memory 12, in which test drive scenario data, possibly with associated additional annotations produced either by a user such as a development engineer, or automatically generated, can be stored in a test drive scenario database.

In addition, the test drive scenario database system 10 shown has a central control device 13 that is, or can be, communicatively connected to the device 11 that generates a virtual scene, the database memory 12, a first test vehicle 16 and to all other components of the system for the purpose of data transmission. The control device has a data receiving unit 14 with a data receiving interface 15, a configuration unit 18 with a user interface 19, and a data output unit 20 with a data output interface 21.

The data receiving unit 14 receives test drive scenario data from a plurality of real test drives of a first test vehicle 16. FIG. 1 shows that the first test vehicle 16 has a first vehicle component 17 to be tested. This can be, for example, control software 16 to be tested belonging to the first test vehicle 16. The control device 13 stores the test drive scenario data received by the data receiving unit 14 in the database memory 12.

The received test drive scenario data comprise at least position data of the first test vehicle 16, which are determined for each of the test drives either continuously or at specific measurement times, e.g. every 0.1 seconds between a beginning and an end of a test drive. To this end, the first test vehicle 16 shown, for example, has a GPS receiver.

In the embodiment of the test drive scenario database system 10 shown, the control device 13 is also connected to a plurality of environmental information databases. A first environmental information database 22 is a weather information database, from which the control device 13 requests relevant weather data on the basis of position data transmitted from the first test vehicle 16 during a test drive. A second environmental information database 23 is a map information database, preferably with information to enable a three-dimensional display of an environment, from which the control device 13 can determine map information data relating to an area surrounding a respective position of the first test vehicle 16. In addition, the control device 13 is connected to a third environmental information database 24, from which traffic information data for an area surrounding a position of the first vehicle 16 is retrieved.

The first test vehicle 16 also has sensors 25, such as radar, lidar and/or image sensors, with which information about the environment, in particular, objects in the environment, are captured. These are transmitted to the data receiving unit 14 of the control device 13 as additional test drive scenario data.

In the embodiment shown, the control device 13 can also collect at least position data from one or more other road users 26, and test drive scenario data from at least a second test vehicle 27 with a second vehicle component 28 to be tested.

The configuration unit 18 has a user interface 19, via which users of the test drive scenario database system 10 can access test drive scenario data received and stored in the database memory 12 and add annotations to it. An annotation, in particular, is a marking of the test drive scenario data of one or more real test drives, or a section or part thereof for the purpose of selecting data to be displayed by the device that generates a virtual scene 11.

The data output unit 20 is configured to output test drive scenario data from real test drives to which an annotation has been added, selected using the configuration unit 18, to the device 11 that generates a virtual scene.

On the basis of the received test drive scenario data, the device 11 that generates a virtual scene generates a virtual test drive scenario, which in turn enables a user of the device parameters to change the test drive scenario data that are output. The user of the device 11 can be the same user who configured the scene to be displayed using the configuration unit 18. It may be, for example, a test person, for example, in the context of a test series for the test vehicle.

In the embodiment shown, the device 11 that generates a virtual scene also has an analysis unit 29, with which dependencies between different test drive scenario data can be analyzed, and is configured to automatically annotate changes in the test drive scenario data that exceed associated tolerance ranges as special events. These annotations are transmitted to the control device 13, which stores them in the database memory 12.

The division shown in FIG. 1 into one block for the device 11 that generates a virtual scene and another for the control device 13 is only one possible embodiment. In other embodiments, the control device 13 and the device 11 that generates a virtual scene, or the analysis unit 29 and the configuration unit 18, are implemented as common modules, for example.

The recording of test drive scenario data for a reconstruction of a realistic virtual test drive scenario during a real test drive using the test drive scenario database system 10 can proceed, for example, as follows:

After the start of a real, test drive, for a sequence of measuring times, for example every 0.1 seconds, the position of the first test vehicle 16 is determined with the aid of GPS and transferred to the control device 13, and a 3D map of an environment of the position of the first test vehicle 16 is retrieved from the second environmental information database 23. The map contains, for example, roads, transport infrastructure, buildings and traffic signs.

For this purpose, positions of other road users 26 are determined, for example, using appropriate databases such as the third environmental information database 24 that provides traffic information, information obtained with the in-vehicle sensors 25 of the first test vehicle 16 or position information obtained, for example, via vehicle-to-vehicle communication from other vehicles, for example of the second test vehicle 27 or smartphone location from pedestrians, cyclists or drivers of other vehicles. In this case, the control device 13 is designed to compare and correct position information obtained via databases or smartphone localization with location information based on an evaluation of an object position information determined by the sensors 25 of the first test vehicle 16. If objects remain, which are located but not identified, a corresponding comment is added to the test drive scenario data.

To enable a more realistic rendering of scenarios by the device 11 that generates a virtual scene, in one embodiment, an orientation of objects, their nearest position and speed is additionally determined and stored. In addition, relevant weather data is retrieved from the first environmental information database 22 that provides the weather data, so that this data can be used when displaying the virtual scene.

If the test vehicle 16 transmits other data, for example, whether headlights are switched on, or doors are closed, then this information is also captured so that it can also be taken into account when displaying the virtual test drive scenario. In addition, if available, traffic signs and, in particular, a sequence of the traffic light states are also captured.

It should be noted in this context that a collection of data on the test drive and its transfer to the control device 13 can be carried out either directly during the test drive, or at a later time, if a data connection can be set up. In this way, the data of the first test vehicle 16 can be recorded first of all, for example in a data recording device on board the test vehicle 16, and the associated environmental data from the environmental information databases 22, 23, 24 can be retrieved later, when the position data of the first test vehicle 16 have been transferred to the control device 13.

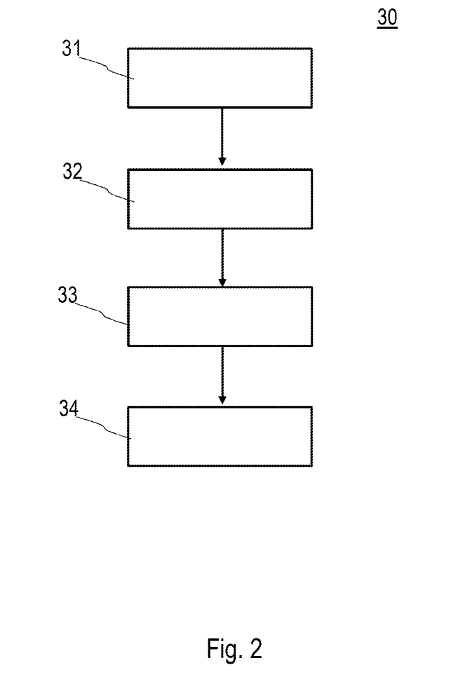

FIG. 2 shows a schematic view of an example of a method for examining test drives with a test drive scenario database system for highly realistic virtual test drive scenarios, in accordance with another embodiment of the disclosure.

The method 30 for examining test drives with a test drive scenario database system for highly realistic virtual test drive scenarios is carried out, for example, with a test drive scenario database system, as shown in FIG. 1. In any event, the test drive scenario database system comprises at least one device that generates a virtual scene, a database memory and a control device at least with a data receiving unit having one or more data receiving interfaces, with a configuration unit having at least one user interface and with a data output unit having at least one data output interface.

In a first method step 31, there is provision for using the data receiving unit to receive test drive scenario data from a plurality of real test drives of at least one first test vehicle, which has at least one first vehicle component to be tested, and store said data in the database memory.

In a second step 32, there is provision for using the configuration unit to add at least one annotation of a user of the test drive scenario database system to test drive scenario data from at least a part of at least one of the plurality of real test drives.

In a third step 33, there is provision for using the data output unit to output test drive scenario data from at least the part of the at least one of the plurality of real test drives, to which the annotation has been added, to the device that generates a virtual scene.

In a fourth method step 34, there is provision for using the device that generates a virtual scene to display the output test drive scenario data in a virtual scenario, in which one or more parameters of the output test drive scenario data can be changed.

The Figures are not necessarily accurate in every detail or true to scale, and can be shown enlarged or reduced in order to provide a better overview. Therefore, functional details disclosed here are not to be understood in a restrictive sense, but merely as a descriptive basis that offers guidance to the person skilled in the art in this field of technology for applying the present disclosure in a variety of ways.

As used herein, the term “and/or”, when used in a series of two or more elements, means that each of the items listed can be used alone, or else any combination of two or more of the listed elements are used. For example, if a combination is described that contains the components A, B and/or C, a combination can contain A alone; B alone; C alone; A and B in combination; A and C in combination; B and C in combination; or A, B, and C in combination.

Although the disclosure has been illustrated and described in greater detail by means of the preferred exemplary embodiments, the disclosure is not restricted by the examples disclosed and other variations can be derived therefrom by the person skilled in the art without departing from the scope of protection of the disclosure.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A test drive scenario database system for highly realistic virtual test drive scenarios, comprising:
a device that generates a virtual scene, and a database memory;
a data receiving unit with one or more data receiving interfaces, configured to receive test drive scenario data from a plurality of real test drives of at least one first test vehicle having at least one first vehicle component to be tested, and store said data in the database memory,
a configuration unit with at least one user interface, configured such that, at least one annotation is added to test drive scenario data from at least a portion of at least one of the plurality of real test drives; and
a data output unit with at least one data output interface, configured to output test drive scenario data from at least the portion of the at least one of the plurality of real test drives, to which the annotation was added, to the device that generates a virtual scene, is the data output unit being configured to display the test drive scenario data in a virtual scenario in which one or more parameters of the output test drive scenario data can be changed.

2. The test drive scenario database system as claimed in claim 1, wherein the test drive scenario data comprises at least position data of the first test vehicle at a plurality of times, or continuously between a corresponding beginning and a corresponding end of a respective test drive.

3. The test drive scenario database system as claimed in claim 2, wherein the test drive scenario data comprises values of at least one other drive parameter of the first test vehicle at the plurality of times, or continuously between the corresponding beginning and the corresponding end of the test drive.

4. The test drive scenario database system as claimed in claim 1, wherein the test drive scenario data comprises environmental data of an area surrounding a position of the first test vehicle.

5. The test drive scenario database system as claimed in claim 4, wherein the environmental data comprises data from at least one environmental information database.

6. The test drive scenario database system as claimed in claim 4, wherein the environmental data comprises additional data that were captured by one or more sensors of the first test vehicle.

7. The test drive scenario database system as claimed in claim 1, wherein the test drive scenario data comprises position data of one or more other road users.

8. The test drive scenario database system as claimed in claim 1, wherein the first vehicle component to be tested comprises a control software, and the one or more parameters of the test drive scenario data are parameters of the control software.

9. The test drive scenario database system as claimed in claim 1, wherein the data receiving unit is configured to receive test drive scenario data from real test drives of at least one second test vehicle, which has at least the first or another vehicle component to be tested, and save said data in the database memory.

10. The test drive scenario database system as claimed in claim 9, wherein the data receiving unit is configured to receive the test drive scenario data of simultaneous real test drives of the first and second test vehicle and store said data in the database memory.

11. The test drive scenario database system as claimed in claim 1, wherein the data receiving unit is configured to receive the test drive scenario data, at least in part, via a wireless connection.

12. The test drive scenario database system as claimed in claim 1, wherein the device that generates a virtual scene comprises an analysis unit configured to analyze dependencies between different test drive scenario data.

13. The test drive scenario database system as claimed in claim 12, wherein the analysis unit is configured to automatically annotate changes in the test drive scenario data, which exceed associated tolerance ranges, as special events.

14. A method for examining test drives with a test drive scenario database system for highly realistic virtual test drive scenarios, comprising:
receiving test drive scenario data from a plurality of real test drives of at least one first test vehicle, which has at least one first vehicle component to be tested using a data receiving unit;
storing the test drive scenario data in a database memory;
adding at least one annotation of a user of the test drive scenario database system to test drive scenario data from at least a part of at least one of the plurality of real test drives using a configuration unit;
outputting test drive scenario data from at least the part of the plurality of real test drives, to which the annotation has been added, using a data output unit, to a displaying device that generates a virtual scene; and
displaying the test drive scenario data in a virtual scenario, on a device that generates the virtual scenario, in which one or more parameters of the test drive scenario data is changed.

15. The method as claimed in claim 14, wherein the test drive scenario data include position data of the first test vehicle at a plurality of times, or continuously between a corresponding beginning and a corresponding end of a respective test drive.

16. The method as claimed in claim 15, wherein the test drive scenario data include values of another drive parameter of the first test vehicle at the plurality of times, or continuously between the corresponding beginning and the corresponding end of the test drive.

17. The method as claimed in claim 14, wherein the test drive scenario data include environmental data from an environmental information database, of an area surrounding a position of the first test vehicle, and additional data captured by sensors of the first test vehicle.

18. The method as claimed in claim 14 further comprising analyzing dependencies between different test drive scenario data via an analysis unit of the device that generates a virtual scene.

19. The method as claimed in claim 18 further comprising automatically annotating changes in the test drive scenario data that exceed associated tolerance ranges as special events via the analysis unit.

20. A vehicle test-drive system comprising:
a receiving unit configured to receive, and store in a database, a scenario from test drives of a first vehicle;
a configuration unit configured to add an annotation to scenario to a portion of the test drives; and
an output unit configured to output the scenario from the portion to an interface to virtually display the scenario, wherein parameters of the scenario can be changed.
